(19) United States
(12) Patent Application Publication
(10) Pub. No.: US 2017/0328324 A1
(43) Pub. Date: Nov. 16, 2017

(54) METHOD AND SYSTEM FOR CONTROLLING FUEL PRESSURE VALVE OF VEHICLE

(71) Applicants: Hyundai Motor Company, Seoul (KR); Kia Motors Corp., Seoul (KR)

(72) Inventor: Su Young PARK, Uiwang-si (KR)

(73) Assignees: Hyundai Motor Company, Seoul (KR); Kia Motors Corp., Seoul (KR)

(21) Appl. No.: 15/345,237

(22) Filed: Nov. 7, 2016

(30) Foreign Application Priority Data
May 12, 2016 (KR) 10-2016-0057870

(51) Int. Cl. F02M 63/00; F02D 41/30; F02D 41/06; F02M 65/00; F02M 63/02

(52) U.S. Cl. CPC F02M 63/0052; F02M 65/003; F02M 63/025; F02D 41/064; F02D 41/3005; F02D 2200/101

(57) ABSTRACT

A method and system for controlling a fuel pressure valve of a vehicle are disclosed. The disclosed control method includes engine start entrance for controlling a controller to increase an allowable deviation between a current target fuel pressure and an actual fuel pressure when an ignition switch-on signal is received by the controller, fuel pressure determination for controlling the controller to determine whether a deviation value between the target fuel pressure and an actual fuel pressure measured by a sensor is greater than an allowable deviation, and valve control for controlling the controller to determine a duty value for control of opening of the fuel pressure valve, and then controlling the controller to open the fuel pressure valve using the determined duty value, thereby decreasing the actual fuel pressure.

### CROSS-REFERENCE TO RELATED APPLICATION

The present application claims the priority benefit of Korean Patent Application No. 10-2016-0057870, filed on May 12, 2016, the disclosure of which is incorporated herein by reference.

### BACKGROUND OF THE INVENTION

### Field of the Invention

The present invention relates to a method and system for controlling a fuel pressure valve of a vehicle, and more particularly to a method and system for controlling a fuel pressure valve to adjust the pressure of a fuel supplied to a fuel injector.

### Description of Related Art

Vehicles may be equipped with a common rail for injecting a fuel at a predetermined high pressure or above. Meanwhile, common rail type engines may be equipped with a fuel pressure valve for adjusting a fuel pressure by feeding back a fuel present in a common rail to a fuel tank.

Such a fuel pressure valve may be of a mechanical type or a solenoid type. In particular, the solenoid type fuel pressure valve is opened when an actual fuel pressure measured by a fuel pressure sensor provided at a common rail differs from a target fuel pressure, to feed back a fuel to a fuel tank, and, as such, the pressure of the fuel present in the common rail approaches the target fuel pressure.

In order for the actual fuel pressure to effectively approach the target fuel pressure, the fuel pressure valve operates repeatedly while being controlled using a duty valve. In a state in which the difference between the actual fuel pressure and the target fuel pressure is small, and such a small difference is maintained, the operation of the fuel pressure valve is continuously carried out and, as such, operation noise may be increased.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to effectively reducing noise generation of a fuel pressure valve to adjust the fuel pressure of a common rail.

In accordance with an aspect of the present invention, the above and other objects can be accomplished by the provision of a method for controlling a fuel pressure valve of a vehicle including engine start entrance for controlling a controller to increase an allowable deviation between a current target fuel pressure and an actual fuel pressure when an ignition switch-on signal is received by the controller, elapsed time determination for controlling the controller to determine whether a time elapsed after reception of the ignition switch-on signal by the controller is greater than a reference time, fuel pressure determination for controlling the controller to determine whether a deviation value between the target fuel pressure and an actual fuel pressure measured by a sensor is greater than the allowable deviation upon determining, at the elapsed time determination, that the time elapsed after reception of the ignition switch-on signal is equal to or less than the reference time, and valve control for controlling the controller to determine a duty value for control of opening of the fuel pressure valve when the deviation value between the target fuel pressure and the measured actual fuel pressure is greater than the allowable deviation, and then controlling the controller to open the fuel pressure valve using the determined duty value, thereby decreasing the actual fuel pressure.

The target fuel pressure may be a variable value determined using a current engine RPM as a parameter.

The control method may further include return for controlling the controller to return the allowable deviation increased at the engine start entrance to a value maintained before the allowable deviation increase upon determining, at the elapsed time determination, that the time elapsed after reception of the ignition switch-on signal is greater than the reference time.

The controller may increase the duty value of the fuel pressure valve as the deviation value between the target fuel pressure and the actual fuel pressure increases.

In accordance with another aspect of the present invention, there is provided a system for controlling a fuel pressure valve of a vehicle including a fuel pressure valve controlled using a duty value, to be opened or closed, the fuel pressure valve functioning to return, to a fuel tank, a fuel supplied to an injector by a fuel pump, thereby achieving a reduction in fuel pressure, a sensor unit for measuring an actual fuel pressure, and a controller for increasing an allowable deviation between a current target fuel pressure and an actual fuel pressure upon receiving an ignition switch-on signal, determining whether a time elapsed after reception of the ignition switch-on signal is greater than a reference time while determining whether a deviation value between the target fuel pressure and an actual fuel pressure measured by the sensor unit is greater than the allowable deviation upon determining, at elapsed time determination, that the time elapsed after reception of the ignition switch-on signal is equal to or less than the reference time, determining a duty value for control of opening of the fuel pressure valve when the deviation value between the target fuel pressure and the measured actual fuel pressure is greater than the allowable deviation, and then opens the fuel pressure valve using the determined duty value, thereby decreasing the actual fuel pressure.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a flowchart illustrating a method for controlling a fuel pressure valve of a vehicle in accordance with an embodiment of the present invention;

FIG. 2 is a diagram illustrating a system for controlling a fuel pressure valve of a vehicle in accordance with an embodiment of the present invention; and

FIG. 3 is a graph depicting operation of the fuel pressure valve controlled through the vehicle fuel pressure valve control method according to the illustrated embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE EXEMPLARY EMBODIMENTS

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Reference will now be made in detail to the exemplary embodiments of the present invention, examples of which are illustrated in the accompanying drawings. Wherever possible, the same reference numbers will be used throughout the drawings to refer to the same or like parts.

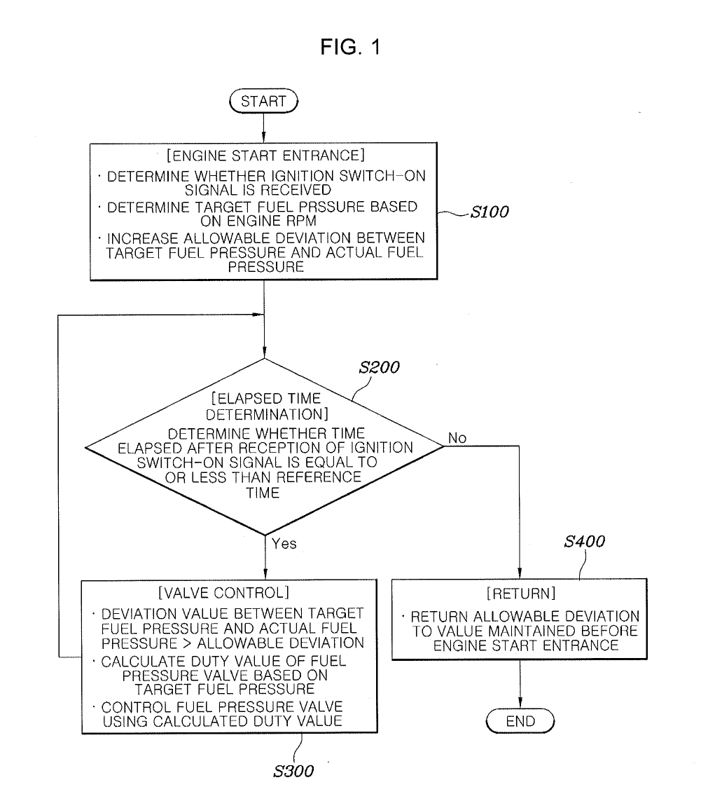

Referring to FIGS. 1 to 3, a method for controlling a fuel pressure valve 150 of a vehicle in accordance with an exemplary embodiment of the present invention is illustrated. As illustrated in FIGS. 1 to 3, the control method includes engine start entrance S100 for controlling a controller 200 to increase an allowable deviation between a current target fuel pressure and an actual fuel pressure when an ignition switch-on signal is received by the controller 200, elapsed time determination S200 for controlling the controller 200 to determine whether the time elapsed after reception of the ignition switch-on signal by the controller 200 is greater than a reference time, fuel pressure determination for controlling the controller 200 to determine whether a deviation value between the target fuel pressure and an actual fuel pressure measured by a sensor is greater than the allowable deviation upon determining, at the elapsed time determination S200, that the time elapsed after reception of the ignition switch-on signal is equal to or less than the reference time, and valve control S300 for controlling the controller 200 to determine a duty value for control of opening of the fuel pressure valve 150 when the deviation value between the target fuel pressure and the measured actual fuel pressure is greater than the allowable deviation, and then controlling the controller 200 to open the fuel pressure valve 150 using the determined duty value, thereby decreasing the actual fuel pressure.

This will be described in detail. At the engine start entrance S100, the controller 200 increases an allowable deviation between a current target fuel pressure and an actual fuel pressure upon receiving an ignition switch-on signal.

When an engine starts after reception of the ignition switch-on signal, the engine abruptly increases in RPM from a value in a stop state to a value in an idle state. In an exemplary embodiment of the present invention, the target fuel pressure is determined based on the RPM of the engine, as will be described below. In this regard, the target fuel pressure also abruptly increases upon engine start in accordance with the engine RPM abruptly increasing upon engine start (in a cranking state).

Meanwhile, in an exemplary embodiment of the present invention, the actual fuel pressure means an actual pressure measured by a sensor unit 220 for a fuel present in a common rail 20. As the target fuel pressure abruptly increases, the actual fuel pressure also abruptly increases in accordance with the target fuel pressure.

In this case, the target fuel pressure is a value calculated by the controller 200, and is maintained at a predetermined value after the engine RPM reaches the idle RPM. The actual fuel pressure is abruptly increased by a fuel pump, the output power of which is abruptly increased, so as to approach the abruptly increasing target fuel pressure. In this case, the actual fuel pressure may exceed the target fuel pressure corresponding to the idle RPM due to influence of just previous fuel pressure increase, after reaching the target fuel pressure. However, the actual fuel pressure is then decreased to be equal to the target fuel pressure.

That is, upon engine start, approach of the actual fuel pressure to the target fuel pressure corresponding to the idle RPM may be delayed. In particular, a procedure in which the actual fuel pressure is decreased after exceeding the target fuel pressure is carried out.

Meanwhile, when the actual fuel pressure exceeds the target fuel pressure such that the deviation value between the actual fuel pressure and the target fuel pressure is greater than the allowable deviation, the fuel pressure valve 150 is opened. In an exemplary embodiment of the present invention, the fuel pressure valve 150 is mounted to the common rail 20, to feed back a fuel when opened. As a portion of the fuel present in the common rail 20 is fed back, the actual fuel pressure is decreased. Thus, the actual fuel pressure measured by the sensor unit 220 approaches the target fuel pressure.

In a conventional case, when the deviation value between the actual fuel pressure and the target fuel pressure is temporarily abruptly increased due to an engine start state of the vehicle, the fuel pressure valve 150 is opened to decrease the actual fuel pressure. Such an operation of controlling the fuel pressure valve 150 is carried out using a duty valve. In this case, accordingly, the fuel pressure valve 150 is repeatedly operated.

In order to enhance the sensitivity of approach of the actual fuel pressure to the target fuel pressure during travel of the vehicle, the allowable deviation between the actual fuel pressure and the target fuel pressure in a normal case may be determined based on experimental values under the condition that the operating time of the fuel pressure valve 150 is reduced, but the number of times when the fuel pressure valve 150 operates is increased, in order to enhance the accuracy and response characteristics of the fuel pressure valve 150.

Of course, when the deviation value between the actual fuel pressure and the target fuel pressure is abruptly increased above a normal level, as in a state in which the engine starts, the number of times when the fuel pressure valve 150 operates is abruptly increased decreasing the actual fuel pressure under the condition that the allowable deviation is maintained at a predetermined value for enhancement in the accuracy and response characteristics of the fuel pressure valve 150.

In an exemplary embodiment of the present invention, accordingly, the controller 200 increases the allowable deviation between the actual fuel pressure and the target fuel pressure such that the allowable deviation exceeds the target value predetermined in association with a normal vehicle travel state, upon receiving the ignition switch-on signal, to increase the unit operating time of the fuel pressure valve 150 while reducing the number of times when the fuel pressure valve 150 operates. Thus, operation noise is reduced. This is possible because there is no problem even when the accuracy and response characteristics of the fuel pressure valve 150 for approach of the actual fuel pressure to the target fuel pressure upon engine start are slightly lower than those in a vehicle travel state.

In this case, the increase in allowable deviation over a predetermined value used in the conventional case may be experimentally or theoretically determined in various manners. For example, when it is assumed that the predetermined allowable deviation in the conventional case is 3.5 MPa, the allowable deviation increased in accordance with the present invention may be determined to be about 10 MPa, corresponding to several times or more the predetermined allowable deviation in the conventional case.

Meanwhile, at the elapsed time determination S200, the controller 200 determines whether the time elapsed after reception of the ignition switch-on signal by the controller 200 is greater than the reference time. As described above, when the allowable deviation is reduced, the accuracy and response characteristics of the fuel pressure valve 150 for approach of the actual fuel pressure to the target fuel pressure are enhanced. On the other hand, when the allowable deviation is increased, the accuracy and response characteristics of the fuel pressure valve 150 for approach of the actual fuel pressure to the target fuel pressure are reduced. In the latter case, however, the number of times when the fuel pressure valve 150 operates is reduced, and the unit operating time of the fuel pressure valve 150 is increased.

Upon engine start, it is advantageous to reduce the number of times when the fuel pressure valve 150 operates, by increasing the allowable deviation, differently than in a vehicle travel state. In a vehicle travel state, however, it is advantageous in terms of fuel economy or engine performance to control the actual fuel pressure to highly reliably approach a target fuel pressure according to variation in engine RPM.

To this end, although the allowable deviation between the actual fuel pressure and the target fuel pressure is increased upon engine start, to reduce operation noise of the fuel pressure valve 150, it is necessary to subsequently return the allowable deviation to a value corresponding to the predetermined value in the conventional case, for a vehicle travel state. In an exemplary embodiment of the present invention, the controller 200 determines whether the time elapsed after reception of the ignition switch-on signal is greater than the reference time. Based on the determined results, it is determined whether the target fuel pressure increased from the predetermined value should be maintained.

The reference time may be determined in various manners based on experimental results or theoretical contents. Preferably, the reference time is determined based on a time when the deviation value between the actual fuel pressure and the target fuel pressure becomes equal to or lower than the allowable deviation as the actual fuel pressure is reduced in accordance with operation of the fuel pressure valve 150 after exceeding the target fuel pressure under the condition that the allowable deviation has been increased.

More preferably, the reference time is determined based on a time when the deviation value between the actual fuel pressure decreased to approach the target fuel pressure in accordance with an increase in allowable deviation and the target fuel pressure becomes equal to or lower than an allowable deviation corresponding to a value maintained before the allowable deviation increase, namely, a predetermined value in the conventional case. In this case, repeated operation of the fuel pressure valve 150 is not required even when the allowable deviation is returned to the predetermined value. Accordingly, there is an advantage in reducing generation of operation noise.

Meanwhile, at the fuel pressure determination, upon determining that the time elapsed after reception of the ignition switch-on signal is equal to or less than the reference time, the controller 200 determines whether a deviation value between the target fuel pressure and an actual fuel pressure measured by the sensor is greater than the allowable deviation.

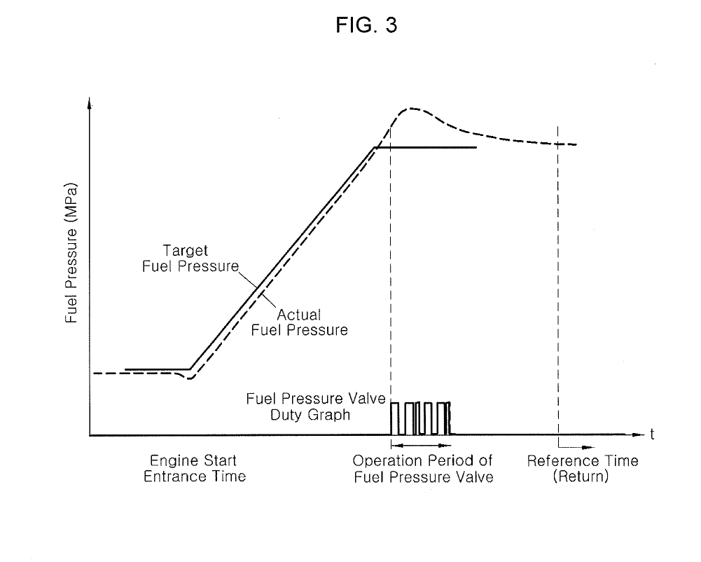

In this case, the operation period of the fuel pressure valve 150 is reduced, as compared to the case in which the allowable deviation between the actual fuel pressure and the target fuel pressure corresponds to the predetermined value in the conventional case. In FIG. 3, the operation period of the fuel pressure valve 150 reduced in accordance with the present invention is illustrated.

Meanwhile, at the valve control S300, upon determining, at the fuel pressure determination, that the deviation value between the target fuel pressure and the actual fuel pressure is greater than the allowable deviation, the controller 200 determines a duty value for control of opening of the fuel pressure valve 150, and then opens the fuel pressure valve 150 using the determined duty value, thereby decreasing the actual fuel pressure.

As the fuel pressure valve 150 operates based on the allowable deviation increased over the predetermined value in the conventional case, the number of times when the fuel pressure valve 150 operates is reduced, as compared to the conventional case. In this case, noise generated due to operation of the fuel pressure valve 150 is also reduced, as compared to the conventional case.

In accordance with the allowable deviation increased over the predetermined value, the actual fuel pressure approaches the target fuel pressure while having a deviation value equal to or lower than the allowable deviation. Subsequently, the actual fuel pressure is gradually decreased toward the target fuel pressure through fuel consumption caused by driving of the engine and adjustment of the output power of the fuel pump and, as such, may become equal to the target fuel pressure.

Meanwhile, in the method of controlling the fuel pressure valve 150 of the vehicle in accordance with the illustrated embodiment of the present invention, the target fuel pressure is a variable value determined using the current engine RPM as a parameter.

As described above, when the engine RPM increases, fuel consumption is also increased. In this state, accordingly, it is necessary to increase the target fuel pressure. In this regard, in an exemplary embodiment of the present invention, the target fuel pressure of the common rail 20 connected to each injector is a variable value determined using an engine RPM as a parameter. The parameter for determining the target fuel pressure may also include the pressing level of an acceleration pedal.

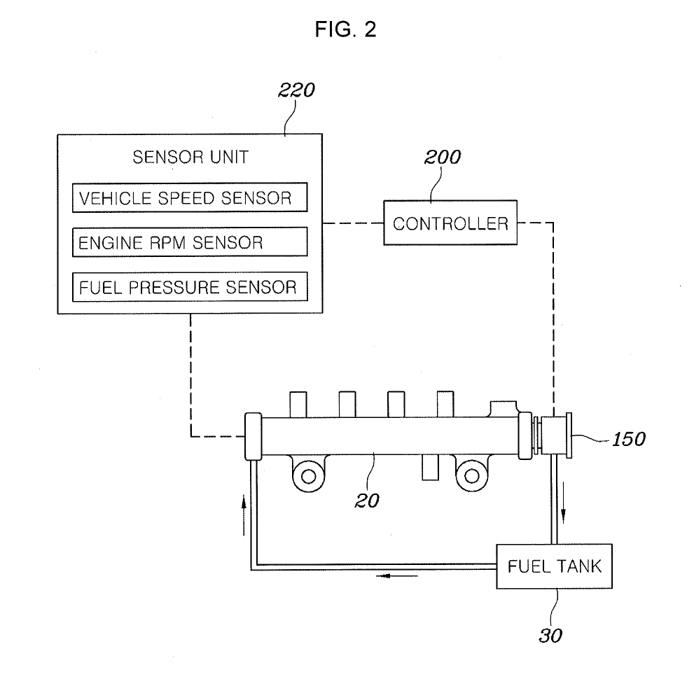

Meanwhile, as illustrated in FIGS. 1 and 2, the method of controlling the fuel pressure valve 150 of the vehicle in accordance with the illustrated embodiment of the present invention further includes return S400 for controlling the controller 200 to return the allowable deviation increased at the engine start entrance S100 to a value maintained before the allowable deviation increase upon determining, at the elapsed time determination S200, that the time elapsed after reception of the ignition switch-on signal is greater than the reference time.

As described above, as a reference for returning, to the predetermined value in the conventional case, the allowable deviation increased over the predetermined value, whether the time elapsed after reception of the ignition switch-on signal is greater than the reference time is determined. When the elapsed time is greater than the reference time, the allowable deviation increased at the engine start entrance S100 is returned to a value maintained before the increase thereof, namely, the predetermined value.

Accordingly, the number of times when the fuel pressure valve 150 operates is reduced during engine cranking in which the number of times when the fuel pressure valve 150 operates is remarkably increased. In a subsequent vehicle travel state, approach of the actual fuel pressure to the target fuel pressure is enhanced.

Meanwhile, as illustrated in FIGS. 1 and 2, in the method of controlling the fuel pressure valve 150 of the vehicle in accordance with the illustrated embodiment of the present invention, the controller 200 increases, at the valve control S300, the duty value of the fuel pressure valve 150 as the deviation value between the target fuel pressure and the actual fuel pressure increases.

In detail, when the deviation value between the target fuel pressure and the actual fuel pressure increases, the level requiring a decrease in actual fuel pressure is also increased. That is, when the deviation value increases, it is advantageous to increase the operating time of the fuel pressure valve 150.

In the illustrated embodiment of the present invention, accordingly, the unit operating time of the fuel pressure valve 150 is increased through an increase in the duty value of the fuel pressure valve 150 when the deviation value increases. In an engine start entrance state, the fuel pressure valve 150 is driven under the condition that the allowable deviation associated with the deviation value is increased. Thus, it may be possible to increase the unit operating time of the fuel pressure valve 150 while reducing the number of times when the fuel pressure valve 150 operates, as compared to the conventional case.

Meanwhile, referring to FIG. 2, a system for controlling the fuel pressure valve 150 of the vehicle in accordance with an exemplary embodiment of the present invention is illustrated. As illustrated in FIG. 2, the control system includes the fuel pressure valve 150, which is controlled using a duty value, to be opened or closed, and functions to return, to a fuel tank 30, a fuel supplied to an injector by a fuel pump, thereby achieving a reduction in fuel pressure, and the sensor unit 220, which functions to measure an actual fuel pressure. The control system further includes the controller 200, which increases an allowable deviation between the current target fuel pressure and the actual fuel pressure upon receiving an ignition switch-on signal, determines whether the time elapsed after reception of the ignition switch-on signal is greater than a reference time, determines whether a deviation value between the target fuel pressure and an actual fuel pressure measured by the sensor unit 220 is greater than the allowable deviation upon determining, at the elapsed time determination S200, that the time elapsed after reception of the ignition switch-on signal is equal to or less than the reference time, determines a duty value for control of opening of the fuel pressure valve 150 when the deviation value between the target fuel pressure and the measured actual fuel pressure is greater than the allowable deviation, and then opens the fuel pressure valve 150 using the determined duty value, thereby decreasing the actual fuel pressure.

This will be described in detail. The opening or closing of the fuel pressure valve 150 is controlled based on a duty value. The fuel pressure valve 150 returns, to the fuel tank 30, a fuel supplied to the injector by the fuel pump, thereby achieving a reduction in fuel pressure, and the sensor unit 220, which functions to measure an actual fuel pressure.

In an exemplary embodiment of the present invention, the injector is connected to the common rail 20. The fuel pressure valve 150 is preferably provided at the common rail 20, to return a fuel present in the common rail 20 to the fuel tank 30. As a result, the fuel pressure established in the common rail 20 is reduced.

Meanwhile, the sensor unit 220 is provided to measure an actual fuel pressure. The sensor unit 220 is preferably connected to the common rail 20, to measure the internal fuel pressure of the common rail 20. The sensor unit 220 also functions to send a value representing the measured actual fuel pressure.

Meanwhile, the controller 200 increases the allowable deviation between the current target fuel pressure and the actual fuel pressure upon receiving an ignition switch-on signal, and determines whether the time elapsed after reception of the ignition switch-on signal is greater than the reference time. Upon determining, at the elapsed time determination S200, that the time elapsed after reception of the ignition switch-on signal is equal to or less than the reference time, the controller 200 determines whether the deviation value between the target fuel pressure and the actual fuel pressure measured by the sensor unit 220 is greater than the allowable deviation. When the deviation value between the target fuel pressure and the measured actual fuel pressure is greater than the allowable deviation, the controller 200 determines a duty value for control of opening of the fuel pressure valve 150, and then opens the fuel pressure valve 150 using the determined duty value, thereby decreasing the actual fuel pressure.

In accordance with the above-described fuel pressure valve control method and system, it may be possible to effectively reduce generation of noise in a fuel pressure valve to adjust the fuel pressure of a common rail.

In particular, when a vehicle ignition switch-on signal is received by the controller, the allowable deviation between the actual fuel pressure and the target fuel pressure is increased over a predetermined value. Accordingly, the actual fuel pressure is abruptly increased to exceed the target fuel pressure due to an abrupt increase of the target fuel pressure caused by an abrupt increase in engine RPM occurring during engine cranking, and is subsequently decreased. As a result, it may be possible to effectively reduce operation noise of the fuel pressure valve.

On the other hand, when the time elapsed after reception of the ignition switch-on signal is greater than a reference time, the allowable deviation increased over the predetermined value is returned to the predetermined value. Accordingly, it may be possible to enhance the accuracy of approach of the actual fuel pressure to the target fuel pressure in a vehicle travel state.

For convenience in explanation and accurate definition in the appended claims, the terms “upper”, “lower”, “inner”, “outer”, “up”, “down”, “upper”, “lower”, “upwards”, “downwards”, “front”, “rear”, “back”, “inside”, “outside”, “inwardly”, “outwardly”, “interior”, “exterior”, “inner”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method for controlling a fuel pressure valve of a vehicle, comprising:
engine start entrance for controlling a controller to increase an allowable deviation between a current target fuel pressure and an actual fuel pressure when an ignition switch-on signal is received by the controller;
elapsed time determination for controlling the controller to determine whether a time elapsed after reception of the ignition switch-on signal by the controller is greater than a predetermined time;
fuel pressure determination for controlling the controller to determine whether a deviation value between the target fuel pressure and an actual fuel pressure measured by a sensor is greater than the allowable deviation upon determining, at the elapsed time determination, that a time elapsed after reception of the ignition switch-on signal is equal to or less than the predetermined time; and
valve control for controlling the controller to determine a duty value for control of opening of the fuel pressure valve when the deviation value between the target fuel pressure and the measured actual fuel pressure is greater than the allowable deviation, and then controlling the controller to open the fuel pressure valve using the determined duty value, thereby decreasing the actual fuel pressure.

2. The method according to claim 1, wherein the target fuel pressure is a variable value determined using a current engine revolution per minute (RPM) as a parameter.

3. The method according to claim 1, further comprising:
return for controlling the controller to return the allowable deviation increased at the engine start entrance to a value maintained before the allowable deviation increase upon determining, at the elapsed time determination, that the time elapsed after reception of the ignition switch-on signal is greater than the predetermined time.

4. The method according to claim 1, wherein the controller increases the duty value of the fuel pressure valve as the deviation value between the target fuel pressure and the actual fuel pressure increases.

5. A system for controlling a fuel pressure valve of a vehicle, comprising:
a fuel pressure valve controlled using a duty value, to be opened or closed, the fuel pressure valve functioning to return, to a fuel tank, a fuel supplied to an injector by a fuel pump, thereby achieving a reduction in fuel pressure;
a sensor for measuring an actual fuel pressure; and
a controller for increasing an allowable deviation between a current target fuel pressure and an actual fuel pressure upon receiving an ignition switch-on signal, determining whether a time elapsed after reception of the ignition switch-on signal is greater than a predetermined time while determining whether a deviation value between the target fuel pressure and the actual fuel pressure measured by the sensor is greater than the allowable deviation upon determining, at elapsed time determination, that the time elapsed after reception of the ignition switch-on signal is equal to or less than the predetermined time, determining a duty value for control of opening of the fuel pressure valve when the deviation value between the target fuel pressure and the measured actual fuel pressure is greater than the allowable deviation, and then opens the fuel pressure valve using the determined duty value, thereby decreasing the actual fuel pressure.
